(19) United States
(12) Patent Application Publication
(10) Pub. No.: US 2026/0177387 A1
(43) Pub. Date: Jun. 25, 2026

(54) COLLABORATIVE MANAGEMENT OF SHARED TRIP ROUTING USING 5G NETWORKING AND EDGE COMPUTING

(71) Applicant: Aptiv Technologies AG, Schaffhausen (CH)

(72) Inventors: Benjamin LYON, Saratoga, CA (US); Paul Miller, Derry, NH (US)

(73) Assignee: Aptiv Technologies AG, Schaffhausen (CH)

(21) Appl. No.: 18/999,300

(22) Filed: Dec. 23, 2024

(51) Int. Cl. G01C 21/34; H04W 4/40

(52) U.S. Cl. CPC G01C 21/3438; H04W 4/40

(57) ABSTRACT

Systems and methods for collaborative management of shared trip routing are provided and include receiving a destination of a shared trip, and transmitting the destination to a multi-access edge computing (MEC) device associated with a telecommunications tower communicating with a first vehicle, the MEC device storing identification and location information of a second vehicle associated with the shared trip. The MEC device communicates routing and navigation information to the first vehicle and communicates the destination to the second vehicle based on the identification and the location information. At least one additional MEC device in communication with the second vehicle generates additional routing and navigation information to guide the at least one second vehicle and communicates the additional routing and navigation information to the second vehicle, which uses the additional routing and navigation information to guide the second vehicle to the destination.

### FIELD

The present disclosure relates to navigation systems and, in particular, to navigation systems that provide collaborative management of shared trip routing using 5G networking and edge computing devices.

### BACKGROUND

This section provides background information related to the present disclosure which is not necessarily prior art.

Navigation systems provide real-time turn-by-turn directions to route a user to a desired destination. With current systems, users traveling in multiple vehicles to a common destination can use separate navigation applications to travel to the common destination. For example, a user can share a destination or route on their personal communication device, such as a smartphone, for use on a similar application on the other user's device. Coordination of the trip, however, can be complicated if one of the users needs to make a stop. Some navigation systems allow a lead user to share their destination and/or route with other users who then use their navigation system to follow the lead user. Again, unplanned stops required by the users following the lead user, however, can render trip coordination difficult. In addition, current systems may utilize only cloud-based servers accessible to each of the users via the Internet. In such case, updated routing instructions or trip changes can be delayed due to network latency and slow communication with the cloud-based server.

### SUMMARY

This section provides a general summary of the disclosure and is not a comprehensive disclosure of its full scope or all of its features.

A method is provided and includes receiving, with a processor of a first vehicle, a destination of a shared trip and transmitting, with a wireless V2X communication device of the first vehicle, the destination to a multi-access edge computing (MEC) device associated with a telecommunications tower communicating with the wireless V2X communication device of the first vehicle, the MEC device storing identification and location information of at least one second vehicle associated with the shared trip. The method further includes generating, with the MEC device, routing and navigation information to guide the first vehicle to the destination and communicating, with the MEC device, the routing and navigation information to the wireless V2X communication device of the first vehicle, the first vehicle using the routing and navigation information to guide the first vehicle to the destination. The method further includes communicating, with the MEC device, the destination to the at least one second vehicle based on the identification and the location information. At least one additional MEC device in communication with the at least one second vehicle generates additional routing and navigation information to guide the at least one second vehicle and communicates the additional routing and navigation information to the at least one second vehicle, the at least one second vehicle using the additional routing and navigation information to guide the at least one second vehicle to the destination.

In other features, the method also includes communicating, with the MEC device, the destination to an application server in communication with the first vehicle and the at least one second vehicle over the Internet.

In other features, the vehicle travels to a new location on the shared trip associated with a second telecommunications tower and the method further comprises communicating, with the wireless V2X communication device of the first vehicle, with a second MEC device associated with the second telecommunications tower, the application server transmitting application code to the second MEC device to perform routing of the first vehicle. The method further comprises receiving, with the processor of the first vehicle, an interim destination of the shared trip. The method further comprises transmitting, with the wireless V2X communication device of the first vehicle, the interim destination to the second MEC device. The method further comprises generating, with the second MEC device, updated routing and navigation information to guide the first vehicle to the interim destination and communicating, with the second MEC device, the updated routing and navigation information to the wireless V2X communication device of the first vehicle, the first vehicle using the updated routing and navigation information to guide the first vehicle to the interim destination.

In other features, the method further comprises communicating, with the second MEC device, the interim destination to the at least one second vehicle. At least one additional MEC device in communication with the at least one second vehicle updates the routing and navigation information to guide the at least one second vehicle and communicates the updated routing and navigation information to the at least one second vehicle, the at least one second vehicle using the updated routing and navigation information to guide the at least one second vehicle to the interim destination.

In other features, the application server stores location and identification for each of the first vehicle and the at least one second vehicle.

In other features, the location and identification information includes location and identification information for at least one of a current telecommunications tower and/or a current MEC device in communication with each of the first vehicle and the at least one second vehicle.

In other features, communication between the MEC device and the application server is prioritized using 5G network slicing over other network traffic.

In other features, the application server stores a listing of registered users authorized to use a trip routing application stored on the application server.

In other features, a listing of registered users authorized to use a trip routing application stored on the application server is distributively stored across a plurality of computing devices using a blockchain.

In other features, the processor of the first vehicle is configured to output a plain language explanation of the routing and navigation information to an occupant of the vehicle, the plain language explanation of the routing and navigation information being generated by use of one of a large language model or a small language model.

In other features, the wireless V2X communication device is a cellular V2X (C-V2X) communication device.

A system is also provided and includes a non-transitory computer-readable medium storing instructions that, when executed by at least one processor of a multi-access edge computing (MEC) device, configure the at least one processor to receive, from a wireless cellular V2X communication device of a first vehicle, a navigation destination of a shared trip, the MEC device being associated with a telecommunications tower communicating with the wireless V2X communication device of the vehicle, and the MEC device storing identification and location information of at least one second vehicle associated with the shared trip. The instructions, when executed, further configure the at least one processor to generate routing and navigation information to guide the first vehicle to the destination and to communicate the routing and navigation information to the wireless V2X communication device of the first vehicle, the first vehicle using the routing and navigation information to guide the first vehicle to the destination. The instructions, when executed, further configure the at least one processor to communicate the destination to the at least one second vehicle based on the identification and the location information. At least one additional MEC device in communication with the at least one second vehicle generates additional routing and navigation information to guide the at least one second vehicle and communicates the additional routing and navigation information to the at least one second vehicle, the at least one second vehicle using the additional routing and navigation information to guide the at least one second vehicle to the destination.

In other features, the instructions, when executed, further configure the at least one processor of the MEC device to communicate the destination to an application server in communication with the first vehicle and the at least one second vehicle over the Internet.

In other features, the vehicle travels to a new location on the shared trip associated with a second MEC device and a second telecommunications tower, and the system further comprises additional instructions, that when executed by at least one processor of the second MEC device, configure the at least one processor of the second MEC device to receive, from the application server, application code to perform routing of the first vehicle, receive from the first vehicle, an interim destination of the shared trip, generate updated routing and navigation information to guide the first vehicle to the interim destination, and communicate the updated routing and navigation information to the wireless V2X communication device of the first vehicle, the first vehicle using the updated routing and navigation information to guide the first vehicle to the interim destination.

In other features, the additional instructions, when executed, further configure the at least one processor of the second MEC device to communicate the interim destination to the at least one second vehicle. At least one additional MEC device in communication with the at least one second vehicle updates the routing and navigation information to guide the at least one second vehicle and communicates the updated routing and navigation information to the at least one second vehicle, the at least one second vehicle using the updated routing and navigation information to guide the at least one second vehicle to the interim destination.

In other features, the application server stores location and identification for each of the first vehicle and the at least one second vehicle.

In other features, the location and identification information includes location and identification information for at least one of a current telecommunications tower and/or a current MEC device in communication with each of the first vehicle and the at least one second vehicle.

In other features, communication between the MEC device and the application server is prioritized using 5G network slicing over other network traffic.

In other features, the application server stores a listing of registered users authorized to use a trip routing application stored on the application server.

In other features, a listing of registered users authorized to use a trip routing application stored on the application server is distributively stored across a plurality of computing devices using a blockchain.

In other features, the wireless V2X communication device is a cellular V2X (C-V2X) communication device.

In other features, the processor of the first vehicle is configured to output a plain language explanation of the routing and navigation information to an occupant of the vehicle, the plain language explanation of the routing and navigation information being generated by use of one of a large language model or a small language model.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments, not all possible implementations, and are not intended to limit the scope of the present disclosure.

FIG. 1 is a block diagram of a 5G networking environment, including vehicles, telecommunications towers, and multi-access edge computing (MEC) devices in accordance with the present disclosure.

FIG. 2 is a block diagram of a vehicle having an infotainment system with a shared trip application in accordance with the present disclosure.

FIG. 3 is a block diagram of a shared trip application server in accordance with the present disclosure.

FIG. 4 is a block diagram of a MEC device having a shared trip application in accordance with the present disclosure.

FIG. 5 is a flow diagram for a method of trip initialization in accordance with the present disclosure.

FIG. 6 is a flow diagram for a method of interim destination collaboration in accordance with the present disclosure.

Corresponding reference numerals indicate corresponding parts throughout the several views of the drawings.

### DETAILED DESCRIPTION

Example embodiments will now be described more fully with reference to the accompanying drawings.

### Overview

The present disclosure provides systems and methods for collaborative management of shared trip routing using 5G networking and edge computing devices. The systems and methods of the present disclosure provide a collaborative navigation solution and applications that allow a number of users to share trip routing and navigation and that coordinate intermediate stops on the shared trip. At any time during the shared trip, each member of the trip can select an interim destination for a “pit-stop,” such as a rest area, gas station, restaurant, etc. The application then determines routing for each member of the trip to the interim stop in real-time and provides navigation instructions to each member of the trip to guide the members to the interim stop. For example, the application can route each member to adjacent or nearby parking spots at the interim destination. Further, as discussed in further detail below, the systems and methods of the present disclosure utilize 5G networking and edge-computing devices for performing updated routing and generating navigation instructions for each vehicle and for coordinating coordinate routing updates to each member vehicle of the shared trip in order to provide high-speed updates and routing/navigation information to each vehicle while avoiding network latency delays.

### System Architecture

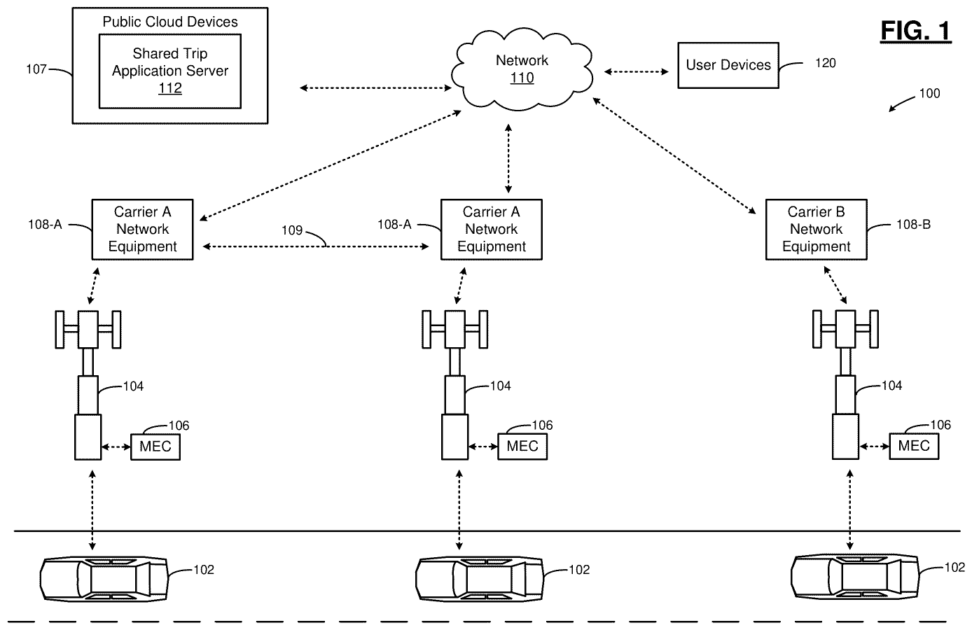

With reference to FIGS. 1 to 4, a 5G networking environment 100 in accordance with the present disclosure is illustrated and includes vehicles 102, telecommunications towers 104, carrier network equipment 108 in communication with a network 110, such as the Internet, and public cloud devices 107, including a shared trip application server 112. The telecommunications towers 104, for example, can be cellular towers. As discussed in further detail below, each vehicle 102 includes communication capabilities. For example, each vehicle 102 can be configured for to communicate using wireless V2X communication, such as cellular V2X (C-V2X) communication and can include a C-V2X communication device 214 configured for communication with the telecommunications towers 104. C-V2X communication, for example, provides for vehicle communication using the 5.9 GHz frequency band and includes a device-to-network communication mode for communication using conventional cellular links for vehicle-to-network (V2N) applications and a device-to-device communication mode for communication without the use of network scheduling for vehicle-to-vehicle (V2V), vehicle-to-infrastructure (V2I), and vehicle-to-pedestrian (V2P) applications. In this way, each of the vehicles 102 are configured for network communication using 5G network communication via telecommunications towers 104, including communication with the shared trip application server 112, and the other vehicles 102, as discussed in further detail below. Further, while C-V2X communication is provided as an example, the vehicle 102 can additionally or alternatively be configured with other wireless communication capabilities in accordance with the present disclosure.

The telecommunications towers 104 in the 5G networking environment 100 are each connected to corresponding carrier network equipment 108. In the example of FIG. 1, two of the telecommunications towers 104 and corresponding carrier network equipment 108-A are operated by a first telecommunications company Carrier A, while the third telecommunications tower 104 and corresponding carrier network equipment 108-B is operated by a second telecommunications company Carrier B. The telecommunications companies can be well-known carriers, such as VERIZON®, AT&T®, etc. In the example of FIG. 1, the carrier A network equipment 108-A is configured for communication with each other, shown by communication line 109. Further, the carrier network equipment 108 communicates with public cloud devices 107, including the shared trip application server 112, via a network 110, such as the Internet.

Each telecommunications tower 104 is in communication with a multi-access edge computing (MEC) device 106. The MEC devices 106 are each located at, and in communication with, a corresponding telecommunications tower 104. Further, each telecommunications tower 104 and corresponding MEC device 106 are located at the same telecommunications base station location for the telecommunications tower 104. As discussed in further detail below, each MEC device 106 can execute an instance of a shared trip application and can communicate with a corresponding vehicle 102 via communication with the telecommunications tower 104 associated with the MEC device 106 to facilitate low-latency communication and quick and efficient updates to the vehicles 102 to enable collaborative management of shared trip routing, in accordance with the present disclosure.

As further shown in FIG. 1, one or more user devices 120 can communicate with the shared trip application server 112 and/or with the vehicles 102 via the network 110, as discussed in further detail below. The user devices 120 can include any type of user computing device, such as a smartphone, tablet, laptop, desktop computer, etc.

### Vehicle Functionality

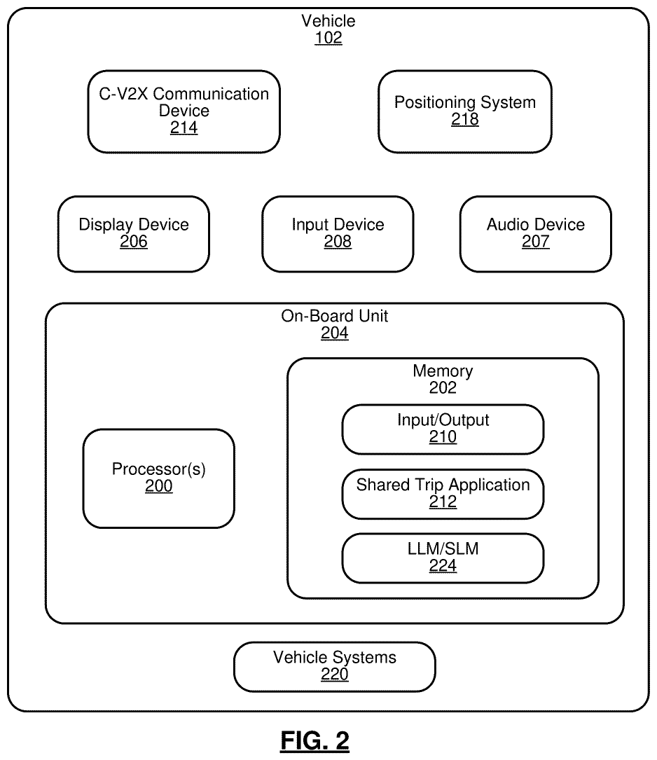

With reference to FIG. 2, each vehicle 102 includes an on-board unit (OBU) 204 with one or more processor(s) 200 and memory 202, a display device 206, an audio device 207, such as a speaker, and an input device. In one example, the OBU 204 can be implemented by, or a part of, an infotainment system that includes the display device 206, the input device 208, and/or the audio device 207. In another example, the OBU 204 can be implemented by, or a part of, a vehicle wireless gateway in communication with the display device 206, the audio device 207, and the input device 208. While an infotainment system and a vehicle wireless gateway are provided as examples, the OBU 204 can be a part of or implemented by any other computing device, such as a general purpose high-performance computing device, or any other vehicle system with sufficient computing resources to perform the described functionality of the present disclosure. The display device 206 and input device 208 can, for example, be part of an integrated touch screen device. The processor(s) 200 can execute code stored in memory 202, such as input/output code 210 to control and output information to the display device 206 and the audio device 207 and to receive information inputted from an occupant of the vehicle 102 via the input device 208. The processor(s) 200 can also execute code for a shared trip application 212 stored in the memory 202, in accordance with the present disclosure and discussed in further detail below.

The vehicle 102 also includes a C-V2X communication device 214 to enable network communication with a telecommunications tower 104 and corresponding MEC device 106, as discussed above. The vehicle 102 also includes a positioning system 218 configured to determine a location of the vehicle 102. For example, the positioning system 218 can include or be part of a global positioning system (GPS). Additionally or alternatively, the positioning system 218 can include or be part of a visual inertial localization system. Additionally or alternatively, the positioning system can include or be part of a dead-reckoning positioning system. Additionally or alternative, the positioning system can include or be part of a localization system that includes lane-level localization functionality and/or navigation level localization functionality.

The processor(s) 200 executing the shared trip application 212 can receive and determine navigation and routing information regarding a current destination of the vehicle 102. The OBU 204 can output the navigation and routing information to an occupant of the vehicle via the display device 206 and/or the audio device 207. The OBU 204 can also communicate the navigation and routing information, including the current destination of the vehicle 102, to additional vehicle systems 220 of the vehicle 200. The additional vehicle systems 220 can include, for example, autonomous driving systems and/or advanced driver assistance systems (ADAS), such as automatic cruise control systems, blind spot monitoring systems, etc. In some example embodiments, the additional vehicle systems 220 can then utilize and process the navigation and routing information appropriately and control steering systems, braking systems, throttle systems, driver alert and warning systems, and/or other systems of the vehicle 102 to autonomously drive the vehicle 102 to the current destination using the navigation and routing information and/or to assist the driver of the vehicle 102 while driving to the destination.

Additionally, the OBU 204 can be configured with, or have access to, a large language model (LLM) or small language model (SLM) 224 stored on the vehicle 102 and can use the LLM/SLM 224 to output plain language explanations via audio output to the audio device 207 and/or via text output to the display device 206. In this way, the OBU 204 can provide contextual information explaining the reasons for any changes in routing or navigation to provide the occupant(s) of the vehicle with comfort and confidence in the system. Additionally or alternatively, a large language model (LLM) or small language model (SLM) 424 can also be located in, or accessible to, the MEC Device 106, which can be used to stream plain language explanations to the vehicle 102 from the MEC device 106, as described in further detail below. In one implementation, for example, an SLM can be located at the vehicle 102 and an LLM can be located at the MEC device 106. In this way, the system can utilize plain language explanations generated and communicated to the vehicle 102 by the MEC device 106 based on the LLM when communication with the MEC device 106 is available and can utilize plain language explanations generated by use SLM located at the vehicle 102 when communication with the MEC device 106 is not available.

### Application Server Functionality

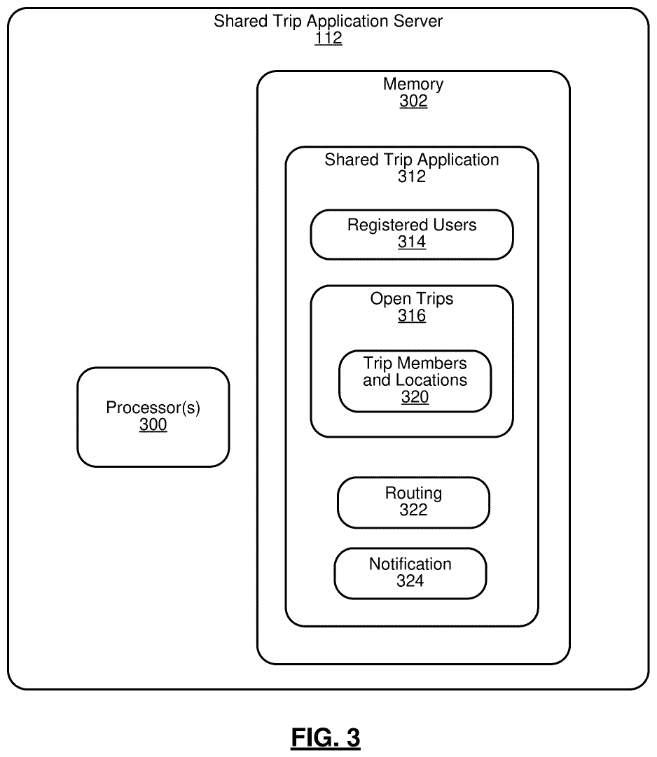

With reference to FIG. 3, the shared trip application server 112 includes one or more processor(s) 300 and memory 302 that stores application code executed by the processor(s) 300. For example, the memory 302 can store code for a shared trip application 312 for execution by the processor(s) 300 to provide server functionality for the collaborative management of shared trip routing in accordance with the present disclosure. The shared trip application 312 includes identification and login/validation information for registered users 314. Alternatively, instead of storing the login/validation information entirely within the memory 302 of the shared trip application server, the login/validation information for registered users can be distributively stored across multiple networked computing devices using a blockchain. In such case, the shared trip application 312 can access the login/validation information stored via the blockchain to perform login/validation services and functionality. For example, users can communicate with the shared trip application server 112 via user devices 120 and/or via the OBU 204 of a vehicle 102 to create an account and login credentials. The shared trip application code 312 also includes identification information for currently open trips 316, including trip member and location information 320 for the trip members associated with the open trip.

A registered user can initiate a new trip, for example, by using the input device 208 in communication with the OBU 204 and the shared trip application 212 executed by the processor(s) 200 of the OBU 204. The shared trip application 212 executed by the vehicle 102 can communicate with the shared trip application 312 executed by the shared trip application server 112 to initiate a new trip based on a destination inputted by the user. The user can also invite other users to the trip and the other users can then accept the invitation and become a member of the shared trip. The shared trip application 312 is further configured to remove or delete users from the trip, as needed. The trip will then remain open until the users reach the inputted destination, or until the users cancel the trip. The shared trip application server 112 stores the current list of open trips at 316, which includes trip member and location information 320 listing the members of the open trip and the locations of each of the members/member vehicles. For example, the shared trip application 112 executed by the server can receive the location of each vehicle 102 for each member associated with the shared trip based on location information generated by the positioning system 218 of the vehicle 102 communicated to the shared trip application server by the vehicle 102 using the C-V2X communication device 214, the telecommunications tower 104, carrier network equipment 108, and network 110. In addition, the trip member and location information 320 can also include a current cell, telecommunications tower, and/or MEC device 106 being used by, and associated with, each vehicle 102. As the vehicles 102 move from cell to cell through the 5G network environment, the cell, telecommunications tower, and MEC device 106 information can be updated by the shared trip application server 112 as the shared trip application server receives such information from the vehicles 102 and/or the MEC devices 106. In addition, when a vehicle 102 becomes associated with a new telecommunications tower 104 and MEC device 106, the shared application server 112 can communicate the shared trip application code 412 (discussed below) for execution by the MEC device 106 while the vehicle 102 is associated with the new cell, telecommunications tower 104, and MEC device 106 for that cell.

The shared trip application server 112 also includes routing code 322 and notification code 324 for determining trip routing and for generating notifications for trip members. As discussed in further detail below, the routing and notification functionality is preferably performed by the MEC devices 106. In the event, however, a MEC device 106 is not available, the shared trip application server 112 can then perform the routing and notification functionality, as needed.

### MEC Device Functionality

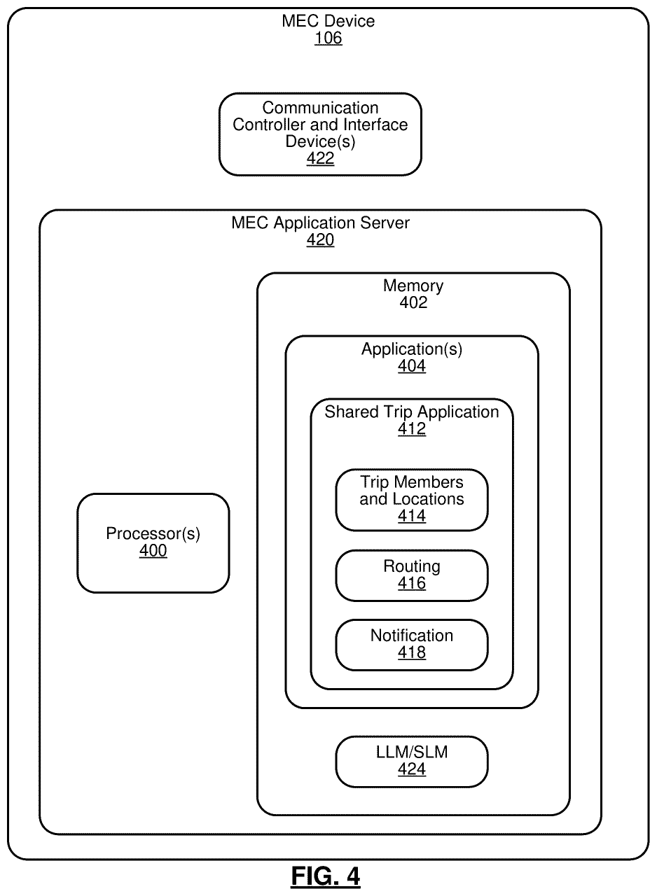

With reference to FIG. 4, the MEC device 106 includes communication controller and interface device(s) for communication via the associated telecommunications tower 104. The MEC device 106 also includes an MEC application server 420 that includes one or more processor(s) 400 and memory 402 that stores application code executed by the processor(s) 300. For example, the memory 302 can execute code for application(s) 404, including the shared trip application code 412 to provide the collaborative management of shared trip routing in accordance with the present disclosure. The shared trip application 412 includes trip member and location information 414, which is similar to the trip member and location information 320 stored by the shared trip application server 112 and discussed above. In particular, the trip member and location information 414 can include identification information for all members of the currently shared trip and location information for each vehicle of the shared trip, including location information, such as GPS location information, and identification information for the cell, telecommunications tower, and/or MEC device currently associated with each vehicle 102 of the shared trip. As the vehicles 102 move through the 5G networking environment 100, the location information and identification information is communicated by the shared trip application 412 executed by processor(s) 400 of the MEC application server 420 via the communication controller and interface device(s) 422. In this way, current and up-to-date identification and location information for the vehicles 102 of the shared trip is maintained and stored by each of the shared trip applications 412 executed by each MEC device 106 and by the shared trip application 312 executed by the shared trip application server 112.

The shared trip application 412 also includes routing code 416 executed by the processor(s) 400 for determining and generating routing and navigation information to a destination or interim destination of the shared trip. For example, a user can input information to the input device 208 in communication with the OBU 204 of the vehicle 102 indicating that the user needs to make a pit stop at a rest area, gas station, restaurant, etc. The user can use the OBU 204 to search for and identify an appropriate location for the pit stop and select the location as an interim destination of the trip. The routing code 416 can then determine updated routing information to route the vehicle 102 to that interim destination. In addition, the processor(s) 400 can then execute notification code 418 to notify all other members of the shared trip of the new interim destination. For example, the shared trip application 412 can use the trip member and location information 414 to generate communication messages to each MEC device 106 and/or vehicle 102 associated with each member of the shared trip. Once each MEC device 106 receives the updated interim destination, the shared trip application 412 executed by the MEC device 106 can then generate and communicate updated routing and navigation information to the associated vehicle 102 using the routing code 416 and notification code 418.

In this way, the computing needed to perform the updated routing and to generate the updated navigation information is quickly performed by the shared trip application 412 executed at the MEC device 106. In this way, the routing for each vehicle is performed at the associated MEC device 106 without the need for the shared trip application server 112 to receive the updated interim destination and generate and communicate updated routing and navigation information for all vehicle 102 of the shared trip. In this way, communication through the network back to the public cloud devices 107 and shared trip application server 112 can be minimized and the required processing can be quickly performed at the edge of the network, close to the location of the vehicles 102 that will ultimately use the routing information.

As noted above, however, in the event a MEC device 106 is not available to perform the required routing and notification functionality for a particular vehicle 102, the shared trip application 212 executed at the vehicle 102 can communicate with the shared trip application server 112 so that routing code 322 of the shared trip application 312 of the shared trip application server 112 can perform the required updated routing to determine the updated routing and navigation information and to notify all members of the trip, as needed.

As further noted above, the MEC device 106 and, in particular, the MEC application server 420 can include or have access to a large language model (LLM) or small language model (SLM) 424 that can be used by the shared trip application 412 to provide plain language explanations to the vehicle 102 for output to occupants of the vehicle 102 via the audio device 207 and/or via the display device 206. In this way, the shared trip application 412 of the MEC application server 420 can provide contextual information explaining the reasons for any changes in routing or navigation to provide the occupant(s) of the vehicle with comfort and confidence in the system. As an example, a large language model (LLM) can be located in, or accessible to, the shared trip application 412 of the MEC application server 420, which can be used by the shared trip application 412 to stream plain language explanations to the vehicle 102 from the MEC device 106. In this way, a larger version of the language model can be stored and used at the MEC device 106 as compared with a smaller version of the language model stored and used at the vehicle 102. As described above, in one example an SLM can be located at the vehicle 102 and an LLM can be located at the MEC device 106. In this way, the system can utilize plain language explanations generated and communicated to the vehicle 102 by the MEC device 106 based on the LLM when communication with the MEC device 106 is available and can utilize plain language explanations generated by using the SLM located at the vehicle 102 when communication with the MEC device 106 is not available. As such, video, audio, and/or text information can be streamed and communicated from the MEC device 106 to the vehicle 102 for output to the occupant(s) of the vehicle 102 via the display device 206 and/or audio device 207.

### Trip Initialization

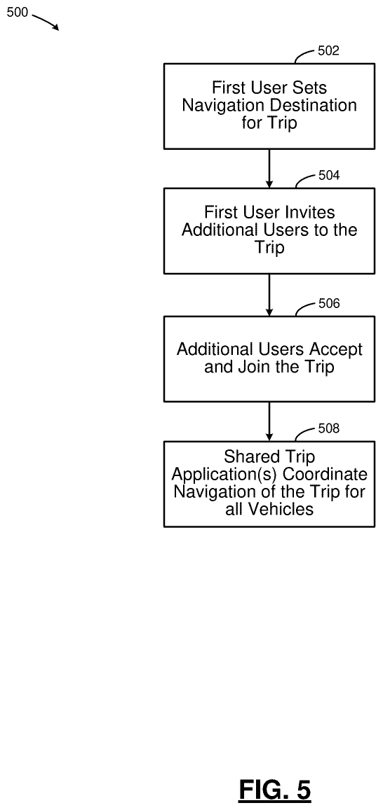

With reference to FIG. 5, a method 500 for trip initialization using the collaborative management of shared trip routing in accordance with the present disclosure is illustrated. At 502, a first user enters a navigation destination for the trip. The navigation destination can be inputted using the input device 208 of the OBU 204 of the vehicle 102. At 504, the first user can invite additional users to the trip 504 by inputting the additional users using the input device 208 of the OBU 204 of the vehicle 102. The invitation requests are then communicated by the shared trip application 212 executing at the vehicle 102 to the shared trip application server 112 executing at the public cloud devices 107. The shared trip application server 112 then notifies each invited member of the invitation to join the trip.

At 506, the additional users accept the invitation and join the trip. The shared trip application server 112 then initiates a new open trip for inclusion in the listing of open trips 312. Once the trip begins, the shared trip application(s) 212, 312, 412 coordinate the shared trip routing and provide routing and navigation instructions to each vehicle of the shared trip, as discussed above.

### Interim Destination Collaboration

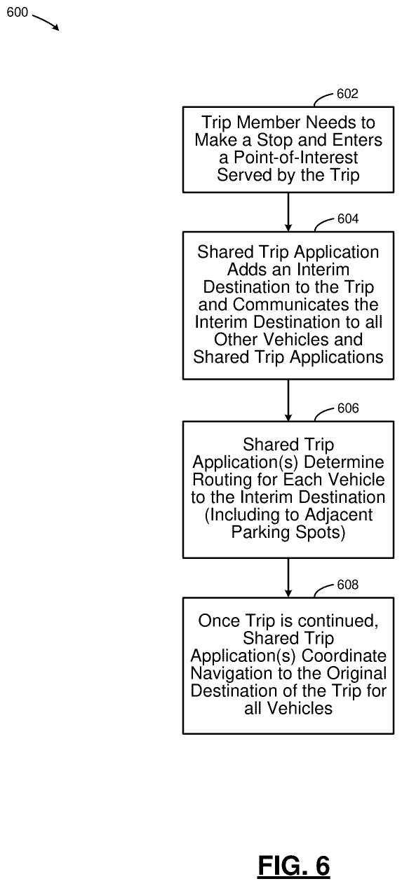

With reference to FIG. 6, a method 600 for making a pit stop on the shared trip by entering an interim destination in accordance with the present disclosure is illustrated. At 602, a member of the shared trip determines that they need to make a pit stop at, for example, a rest area, gas station, restaurant, etc., and enters and searches for an applicable point-of-interest served by the trip. At 604, the point-of-interest is added to the shared trip as an interim destination, which is communicated to each of the member vehicles 102, as discussed above.

At 606, the shared trip application 412 executing at the MEC device 106 determines the updated routing and navigation information and communicates the updated routing and navigation information to the corresponding vehicle 102. The shared trip application 212 executing at the vehicle 102 then outputs the updated routing and navigation information using the OBU 204 to guide the vehicle 102 to the interim destination. Additionally or alternatively, the additional vehicle systems 220 can autonomously drive the vehicle 102 to the interim destination and/or assist the driver in driving to the interim destination. If possible, the updated routing and navigation information can include guiding the vehicles 102 of the shared trip to adjacent or nearby parking spots at the interim destination.

At 608, once the pit stop is concluded, the trip resumes and the shared trip applications 212, 312, 412 continue to coordinate and provide routing and navigation guidance for the original or previous destination to the vehicles 102.

In this way, the systems and methods of the present disclosure efficiently provide collaborative management of shared trip routing using 5G networking and edge computing device to quickly perform updated routing and navigation guidance at the edge of the network, without the need to communicate to the public cloud device, for all members of a shared trip.

### 5G Network Slicing Features

As noted above, the functionality for performing collaborative management of shared trip routing is beneficially and preferably performed at the edge of the 5G network by MEC devices 106 to quickly and efficiently provide updated routing and navigation guidance to the vehicles 102.

In addition, 5G network slicing can also be used to prioritize packets of information communicated by the shared trip applications 212, 312, 412 to further increase the speed of the communication between vehicles 102 and decrease communication latency. In particular, service level agreements can be utilized to provide a predetermined level of quality of service (QOS) and bandwidth through the network environment and ensure that updates are provided quickly and prioritized over network traffic.

### Computation Offloading Features

In some embodiments, functionality performed by the shared trip application 212 normally executed in the vehicle 102 can be offloaded to the shared trip application 412 executed at the MEC device 106. For example, a particular vehicle 102 may not have sufficient computational resources to perform the necessary processing for the shared trip application 212. In that case, the MEC application server 420 can perform the functionality usually performed by the shared trip application 212 in the vehicle 102. In such case, the vehicle 102 can serve as a terminal with the display device 206 and input device 208 and the shared trip application 412 executed by the MEC device 106 can communicate with the display device 206 and input device 208 to control the display device 206 and receive input from the input device 208. In this way, the OBU 204 of the vehicle would serve as an input/output device for the MEC device 106.

### Other Edge Computing Devices

While the present disclosure describes using a shared trip application 412 executed by a MEC device 106, other edge computing devices can be used in accordance with the systems and methods of the present disclosure. For example, other edge computing devices, near the vehicles 102 could alternatively be used. For example, a roadside unit (RSU) could be configured with sufficient computing resources to execute a shared trip application. In such case, the vehicles 102 could communicate with the RSU performing the shared trip application functionality, similar to that described above with respect to the MEC devices 106.

Additionally or alternatively, the vehicle itself can serve as an edge computing device. For example, in the event the vehicle 102 includes sufficient computational resources and communication capabilities to serve as an edge computing device, then the vehicle 102 can execute and perform the functionality and communication described above as being performed by the MEC device 106.

### Additional Applications

While the example of a group of vehicles 102 on a shared trip is discussed above, the present disclosure can also be utilized with other applications for collaborative management of a shared set of goals. For example, the systems and methods of the present disclosure can be used for dispatch, tracking, and routing for long-haul trucking caravans, including autonomously driven long-haul trucking caravans. Further, while examples are provided above for vehicles traveling on a roadway, the systems and methods of the present disclosure can be also be applied and used with aviation travel.

### Terminology

The foregoing description of the embodiments has been provided for purposes of illustration and description and is not intended to be exhaustive or to limit the disclosure. Individual elements or features of a particular embodiment are generally not limited to that particular embodiment, but, where applicable, are interchangeable and can be used in another embodiment, even if not specifically shown or described. The various embodiments may also be varied in many ways. Such variations are not to be regarded as a departure from the disclosure, and all such modifications are intended to be included within the scope of the disclosure. Although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Example embodiments are provided so that this disclosure will be thorough and will fully convey the scope to those who are skilled in the art. Specific details are set forth, including examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

In the written description and claims, one or more steps within a method may be executed in a different order (or concurrently) without altering the principles of the present disclosure. Similarly, one or more instructions stored in a non-transitory computer-readable medium may be executed in different order (or concurrently) without altering the principles of the present disclosure. Unless indicated otherwise, numbering or other labeling of instructions or method steps is done for convenient reference and not to indicate a fixed order.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

The phrase “at least one of A, B, and C” should be construed to mean a logical (A OR B OR C), using a non-exclusive logical OR, and should not be construed to mean “at least one of A, at least one of B, and at least one of C.” The term “set” does not necessarily exclude the empty set. The term “non-empty set” may be used to indicate exclusion of the empty set. The term “subset” does not necessarily require a proper subset. In other words, a first subset of a first set may be coextensive with (equal to) the first set.

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media.

The apparatuses and methods described in this application may be partially or fully implemented by a special purpose computer created by configuring a general-purpose computer to execute one or more particular functions embodied in computer programs. Such apparatuses and methods may be described as computerized apparatuses and computerized methods. The functional blocks and flowchart elements described above serve as software specifications, which can be translated into computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A method comprising:
receiving, with a processor of a first vehicle, a destination of a shared trip;
transmitting, with a wireless V2X communication device of the first vehicle, the destination to a multi-access edge computing (MEC) device associated with a telecommunications tower communicating with the wireless V2X communication device of the first vehicle, the MEC device storing identification and location information of at least one second vehicle associated with the shared trip;
generating, with the MEC device, routing and navigation information to guide the first vehicle to the destination;
communicating, with the MEC device, the routing and navigation information to the wireless V2X communication device of the first vehicle, the first vehicle using the routing and navigation information to guide the first vehicle to the destination; and
communicating, with the MEC device, the destination to the at least one second vehicle based on the identification and the location information;
wherein at least one additional MEC device in communication with the at least one second vehicle generates additional routing and navigation information to guide the at least one second vehicle and communicates the additional routing and navigation information to the at least one second vehicle, the at least one second vehicle using the additional routing and navigation information to guide the at least one second vehicle to the destination.

2. The method of claim 1, further comprising:
communicating, with the MEC device, the destination to an application server in communication with the first vehicle and the at least one second vehicle over the Internet.

3. The method of claim 2, wherein the vehicle travels to a new location on the shared trip associated with a second telecommunications tower, the method further comprising:
communicating, with the wireless V2X communication device of the first vehicle, with a second MEC device associated with the second telecommunications tower, the application server transmitting application code to the second MEC device to perform routing of the first vehicle;
receiving, with the processor of the first vehicle, an interim destination of the shared trip;
transmitting, with the wireless V2X communication device of the first vehicle, the interim destination to the second MEC device;
generating, with the second MEC device, updated routing and navigation information to guide the first vehicle to the interim destination; and
communicating, with the second MEC device, the updated routing and navigation information to the wireless V2X communication device of the first vehicle, the first vehicle using the updated routing and navigation information to guide the first vehicle to the interim destination.

4. The method of claim 3, further comprising:
communicating, with the second MEC device, the interim destination to the at least one second vehicle;
wherein at least one additional MEC device in communication with the at least one second vehicle updates the routing and navigation information to guide the at least one second vehicle and communicates the updated routing and navigation information to the at least one second vehicle, the at least one second vehicle using the updated routing and navigation information to guide the at least one second vehicle to the interim destination.

5. The method of claim 2, wherein the application server stores location and identification for each of the first vehicle and the at least one second vehicle.

6. The method of claim 5, wherein the location and identification information includes location and identification information for at least one of a current telecommunications tower and/or a current MEC device in communication with each of the first vehicle and the at least one second vehicle.

7. The method of claim 2, wherein communication between the MEC device and the application server is prioritized using 5G network slicing over other network traffic.

8. The method of claim 2, wherein the application server stores a listing of registered users authorized to use a trip routing application stored on the application server.

9. The method of claim 1, where a listing of registered users authorized to use a trip routing application is distributively stored across a plurality of computing devices using a blockchain.

10. The method of claim 1, wherein the processor of the first vehicle is configured to output a plain language explanation of the routing and navigation information to an occupant of the vehicle, the plain language explanation of the routing and navigation information being generated by use of one of a large language model or a small language model.

11. The method of claim 1, wherein the wireless V2X communication device is a cellular V2X (C-V2X) communication device.

12. A system comprising a non-transitory computer-readable medium storing instructions that, when executed by at least one processor of a multi-access edge computing (MEC) device, configure the at least one processor to:
receive, from a wireless cellular V2X communication device of a first vehicle, a destination of a shared trip, the MEC device being associated with a telecommunications tower communicating with the wireless V2X communication device of the vehicle, and the MEC device storing identification and location information of at least one second vehicle associated with the shared trip;
generate routing and navigation information to guide the first vehicle to the destination;
communicate the routing and navigation information to the wireless V2X communication device of the first vehicle, the first vehicle using the routing and navigation information to guide the first vehicle to the destination; and
communicate the destination to the at least one second vehicle based on the identification and the location information;
wherein at least one additional MEC device in communication with the at least one second vehicle generates additional routing and navigation information to guide the at least one second vehicle and communicates the additional routing and navigation information to the at least one second vehicle, the at least one second vehicle using the additional routing and navigation information to guide the at least one second vehicle to the destination.

13. The system of claim 12, wherein the instructions, when executed by the at least one processor of the MEC device, further configure the at least one processor to communicate the destination to an application server in communication with the first vehicle and the at least one second vehicle over the Internet.

14. The system of claim 13, wherein the vehicle travels to a new location on the shared trip associated with a second MEC device and a second telecommunications tower, the system further comprising additional instructions, that when executed by at least one processor of the second MEC device, configure the at least one processor of the second MEC device to:
receive, from the application server, application code to perform routing of the first vehicle;
receive from the first vehicle, an interim destination of the shared trip;
generate updated routing and navigation information to guide the first vehicle to the interim destination; and
communicate the updated routing and navigation information to the wireless V2X communication device of the first vehicle, the first vehicle using the updated routing and navigation information to guide the first vehicle to the interim destination.

15. The system of claim 14, wherein the additional instructions, when executed by at least one processor of the second MEC device, configure the at least one processor of the second MEC device to:
communicate the interim destination to the at least one second vehicle;
wherein at least one additional MEC device in communication with the at least one second vehicle updates the routing and navigation information to guide the at least one second vehicle and communicates the updated routing and navigation information to the at least one second vehicle, the at least one second vehicle using the updated routing and navigation information to guide the at least one second vehicle to the interim destination.

16. The system of claim 14, wherein the application server stores location and identification for each of the first vehicle and the at least one second vehicle.

17. The system of claim 16, wherein the location and identification information includes location and identification information for at least one of a current telecommunications tower and/or a current MEC device in communication with each of the first vehicle and the at least one second vehicle.

18. The system of claim 13, wherein communication between the MEC device and the application server is prioritized using 5G network slicing over other network traffic.

19. The system of claim 13, wherein the application server stores a listing of registered users authorized to use a trip routing application stored on the application server.

20. The system of claim 12, wherein a listing of registered users authorized to use a trip routing application is distributively stored across a plurality of computing devices using a blockchain.

21. The system of claim 12, wherein the wireless V2X communication device is a cellular V2X (C-V2X) communication device.

22. The system of claim 12, wherein the processor of the first vehicle is configured to output a plain language explanation of the routing and navigation information to an occupant of the vehicle, the plain language explanation of the routing and navigation information being generated by use of one of a large language model or a small language model.
